(19) United States
(12) Patent Application Publication
(10) Pub. No.: US 2022/0348384 A1
(43) Pub. Date: Nov. 3, 2022

(54) Resealable Beverage Container and Method of Manufacture

(71) Applicant: Bobbie URIBE, ARVADA, CO (US)

(72) Inventor: Bobbie URIBE, ARVADA, CO (US)

(21) Appl. No.: 17/306,362

(22) Filed: May 3, 2021

(51) Int. Cl. B65D 43/14; B65D 8/00; B65D 51/16; B67C 7/00; B21D 51/26

(52) U.S. Cl. CPC B65D 43/14; B65D 7/04; B65D 51/1688; B67C 7/00; B21D 51/26; B65D 2543/00046; B65D 2543/00092; B65D 2543/00981

(57) ABSTRACT

A resealable beverage container having an upper portion disposed overtop the container end and a base seamed into the open end. The container end incudes an impermeable gasket member disposed exteriorly thereupon, overtop of which the upper portion is engaged. The upper portion is rotatable between an open position and a closed position to orient at least one opening from sealed engagement with the gasket member to superimpose over at least one corresponding opening in the container end. The container may therefore be closed after opening to store contents therein. The container is manufactured using a modification to standard industry practices as seen in the art whereby minimal retooling is required for industry adoption.

### BACKGROUND OF THE INVENTION

Means of providing disposable containers for beverages are long established in the art. Most such containers are rendered as single-use receptacles wherein opening of the receptacle unseals the contents. After the beverage is consumed the receptacle is thrown away or recycled.

Once opened, the beverage is exposed to atmosphere and will decarbonate and oxidize over time. Beverages therefore must be consumed in a relatively short time after opening else the beverage lose its vitality. As a result, single-serving sized containers are generally wasteful and incentivize overconsumption. An abundance of sugared and artificially sweetened beverages demanded by the market has been associated with obesity, diabetes, and other ailments plaguing the population. Moreover, such receptacles once opened are prone to spillage—since there is no available means to seal the beverage container once opened, knocking the container over subjects the contents to spillage. This is particularly problematic when drinking while traveling, as for example when flying or driving.

What is needed is a resealable beverage container that enables a user to easily open the receptacle and then reseal the container when not in use. A method of manufacture that enables retooling of existing methods of production is also desirable to incentivize cost-effective adoption of the invention.

### FIELD OF THE INVENTION

The present invention relates to a resealable beverage container capable of resealing its contents after opening by rotational action of an upper portion disposed to orient a drink hole between a closed position and an open position, to prevent spillage and maintain carbonation of the beverage during extended use. The present invention further relates to a method of manufacture of the resealable beverage container that modifies existing production methods for addition of an upper portion to a can end.

### SUMMARY OF THE INVENTION

The present invention and method of manufacture relate to a resealable beverage container having a rotatable upper portion that aligns a drink hole therein with a drink hole disposed in the container end. The container is resealable after opening. The upper portion is moveable between a closed position and an open position when rotated in a corresponding first direction and a corresponding second direction, respectively. When oriented to the open position, the drink hole in the upper portion superimposes overtop a corresponding drink hole in the container end. When oriented to the closed position, the drink hole of the upper portion engages overtop an impermeable gasket member whereby the container is sealed (and re-seals). The upper portion may be prevented from over-rotation by action of at least one detent or other obstructing member to prevent the upper portion from rotating past the open and closed positions.

It should be noted that, although the present disclosure is directed to a beverage can in particular, the principal means of exploiting the inventive step set forth herein, and the associated metes and bounds of the claims below, necessarily apply to beverage containers of any material wherein the general form of the receptacle is maintained. The method of manufacture contemplates adoption in the beverage can and canning industry as a whole and is directed to assembly of an aluminum can as seen in the current state of the art; however, where additional materials can be used to like effect without deviating from the general intent of the steps enumerated in the method as claimed, other materials are also contemplated as appropriate for, and within scope of, the method claimed.

In contemplating the present invention, some embodiments include a vent hole disposed in the container end whereby a corresponding vent hole in the upper portion enables atmospheric displacement therethrough when the upper portion is moved to the open position. The vent hole enables displacement of atmosphere into the container when decanting or drinking liquid therefrom. In like manner as described above, where included, the vent hole in the upper portion is sealed by the impermeable gasket member when the upper portion is rotated to the closed position to prevent leakage when the beverage container is closed.

The impermeable gasket member may be a single body superimposed atop the container end between the container end and the upper portion or it may comprise a plurality of such bodies disposed in requisite position to seal with such openings as are disposed in the upper portion while enabling superimposition with corresponding openings in the container end. The impermeable gasket member may be rendered of any impermeable nontoxic material, such as food grade silicone, for example, or other nontoxic polymer suited for the purpose, and it may be installed via a variety of methods, including by spraying an aerosolized polymer or other substance to gel upon the can end in requisite position for the purposes intended. In other methods, the impermeable gasket member may be premade and added in the assembly line to the drawing of the aluminum blank at an appropriate stage in the manufacturing process. In other methods, the impermeable gasket member may be additively printed to the can end.

In some modes of manufacture contemplated herein, the impermeable gasket member is added to the container end and punched to render openings therein superimposed with openings in the container end. The upper portion may also be added to the container end for punching simultaneously and set to position rotationally around the can end (see below) whereby the openings in the upper end are rotatable to superimpose over the openings in the gasket and container end when the upper portion is moved to the open position. The openings in the upper portion are thence set to reseal with the gasket member when the upper portion is returned to the closed position.

Thus, in all embodiments, the impermeable gasket member enables sealable contact with openings disposed in the upper portion to prevent leakage when the upper portion is moved to the closed position while enabling throughflow to the container interior when the upper portion is moved to the open position.

In some embodiments, over-rotation of the upper portion between the open and closed positions may be effectuated by engagement of an obstruction member (herein, “detent”) devised to delimit rotation of the upper portion by engagement within a corresponding track. In the preferred embodiment set forth and illustrated herein, the detent (or other obstruction member) is disposed upon the upper portion and travels in an arcuate track scored in the gasket member and/or the can end. The extent of the track delimits the degree of rotation; the extremities of the track corresponding to the open and closed positions respectively. It should be noted that the detent (or other obstruction member) may be disposed in other positions to like effect, such as, for example, upon the side of the upper portion and travelable thereat along a track scored in the container end, or, vice versa, on the can end whereby the track is disposed on the interior surface of the upper portion and therefore moveable around the detent.

In some embodiments, the gasket member includes a vent hole, a drink hole, and a track member. The vent hole and drink hole are positioned to superimpose atop the vent hole and the drink hole in the container end and said track member accommodates movement of a corresponding detent between the open and closed positions therein to prevent over-rotation of the upper portion. The track member may likewise be scored in the can end proper where the gasket member is not coextensive with the can end.

To incentivize adoption of the invention, the method of manufacture of the beverage container set forth herein is contemplated for standard industry manufacturing practices, as currently seen in the beverage can arts. In brief, a beverage can is typically made in the state of the art by a process known as two-piece drawing and wall ironing. An aluminum ingot is pressed into a circular sheet blank. A cup is then drawn from this blank to be approximately 3.5″ in diameter and 1.3″ in height. This cup is then extended in a second draw to approximately 2.6″ diameter and 2.25″ height and subsequently ironed to approximately 5″ height. Typically, another punch arches the base to counter the pressure of the stored liquid inside the can. However, in the present method set forth herein, this phase is omitted, thereby providing a cup with a flat base.

Ears are trimmed from the upper rim and the neck is added to the upper end. Typically, as seen in the art, a flat lid of a stiffer aluminum alloy (typically with a higher percentage of manganese) is added. After the beverage is input into the can, the lid is folded into the neck and seamed closed. However, in the instant process set forth herein, the lid is seamed without a drink hole scored or a ring pull added. In the present method, this lid serves as the base of the can (the stronger aluminum needed to counteract the pressure) and the flat base is presented as the container end whereon the upper portion is added in an additional step over the current method seen in the art.

In the present method, instead of bulging the base, the upper portion is added thereover. Openings may then be punched therethrough or, alternatively, the upper portion may be assembled in a process separately and be added to the can end with suitable openings (whether drink hole only or drink hole and other openings) previously punched.

In the present invention, the base of the cup manufactured in the present state of the art serves as the “container end” of the container as set forth herein. In a preferred embodiment, the upper portion is made of aluminum (potentially with a higher manganese content to ensure stiffness) and is sized to superimpose overtop the container end. During the drawing and ironing phase, the container end is shouldered. The upper portion engages over the shouldered portion to align with the can walls. A V-crimp is then added, engaging the upper portion into the can wall around the shoulder. Liquid is added under pressure and the can lid is added to form the base of the beverage container in the manner previously described, but without the need of a drink hole or ring pull added.

In the present method of manufacture, the impermeable gasket is installed to the can base before the upper portion is added thereover. The gasket may be premade with openings therein and, where present, with the track incorporated. Alternatively, the openings in the container end may be punched simultaneously through the gasket. Additionally, the gasket may be added to the container end by spraying or additively printing a polymer thereto at time of drawing out the cup (see above). The upper portion is then added and situated in the closed position. The detent (or other obstruction member), when present, may be added to the upper portion at time of manufacture or added in the process crimping the upper portion to the container shoulder.

Once the upper portion has been attached, and the V-crimp added, the liquid is added under pressure and the lid installed in the typical fashion by seaming into the cup open end. The pressure of the liquid forces the upper portion into taut engagement with the gasket and seals the container. The result is a sealed can containing a pressurized liquid with a rotatable upper portion that may be operated from the closed position to the open position to open and close, unseal and reseal, the beverage therein contained. No ring pull is needed. Twisting the can to the open position releases the pressure interior to the can.

Thus has been broadly outlined the more important features of the present resealable beverage container so that the detailed description thereof that follows may be better understood and in order that the present contribution to the art may be better appreciated.

Objects of the present resealable beverage container, along with various novel features that characterize the invention are particularly pointed out in the claims forming a part of this disclosure. For better understanding of the resealable beverage container, its operating advantages and specific objects attained by its uses, refer to the accompanying drawings and description.

### BRIEF DESCRIPTION OF THE DRAWINGS

### Figures

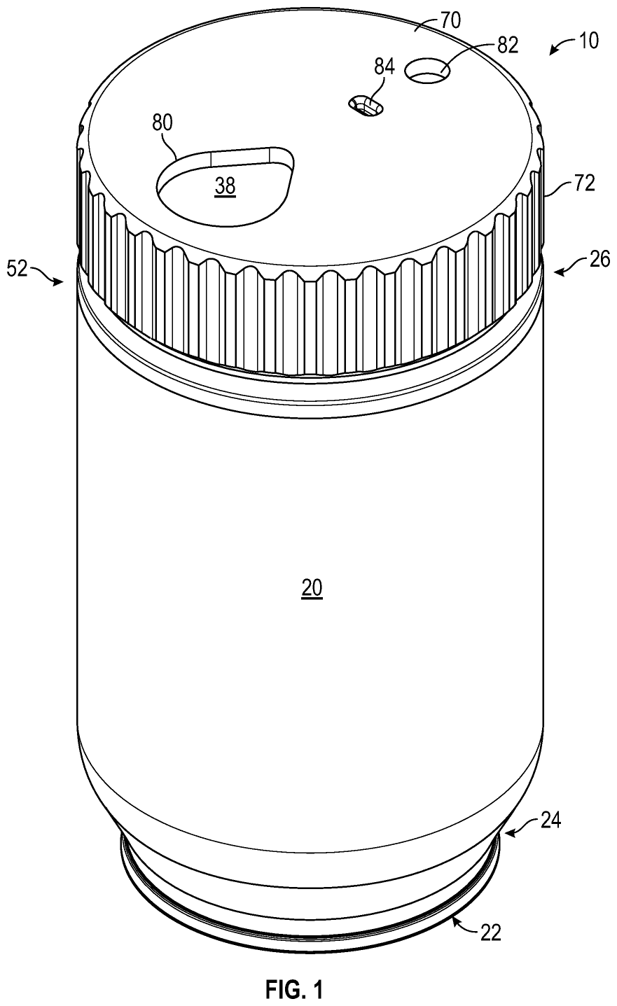

FIG. 1 is a raised elevation view of an example embodiment of the resealable beverage container.

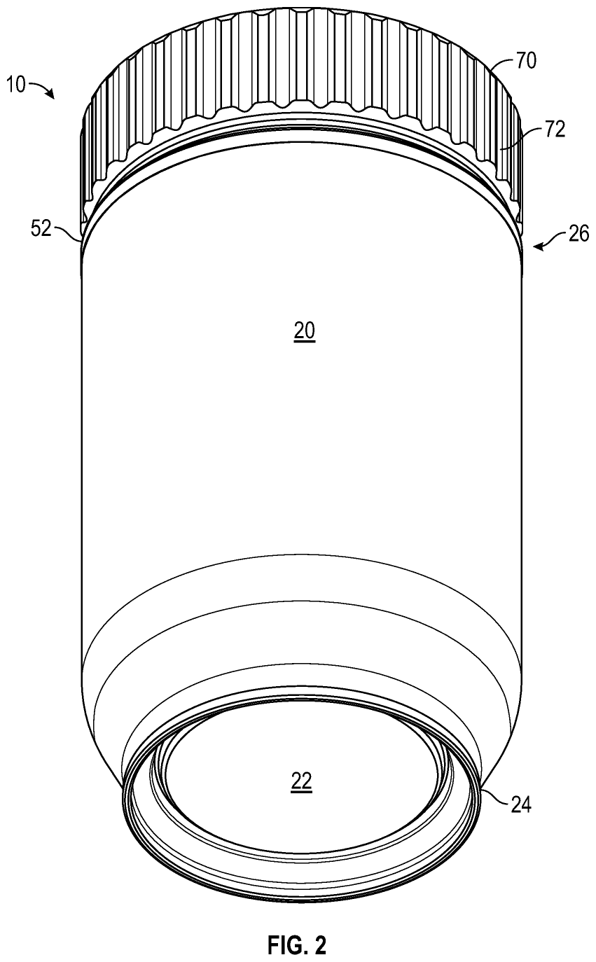

FIG. 2 is a lowered elevation view an example embodiment.

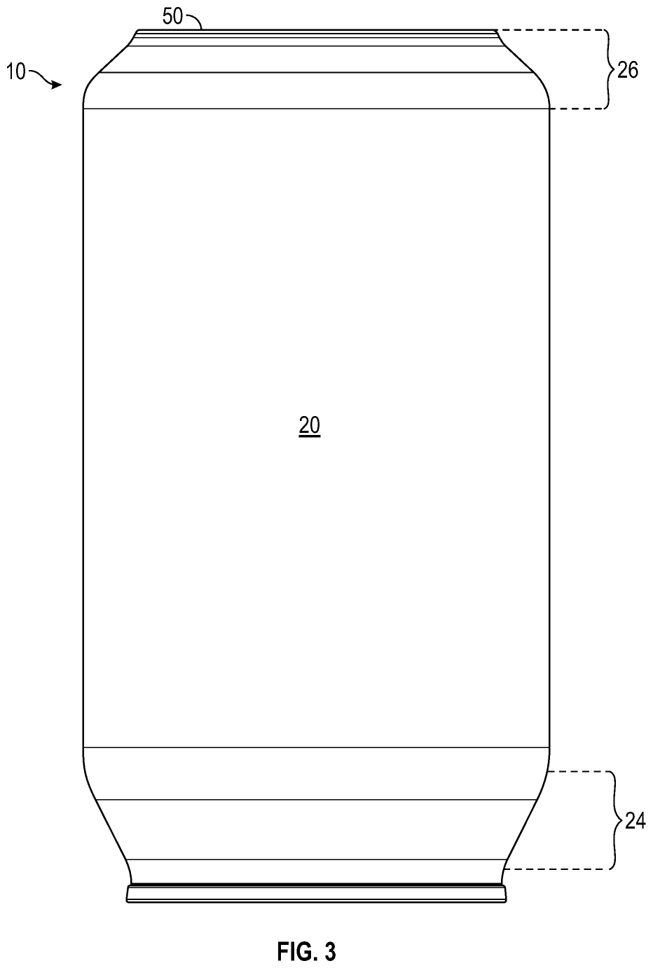

FIG. 3 is a side elevation view of an example embodiment before the upper portion is added to the container end.

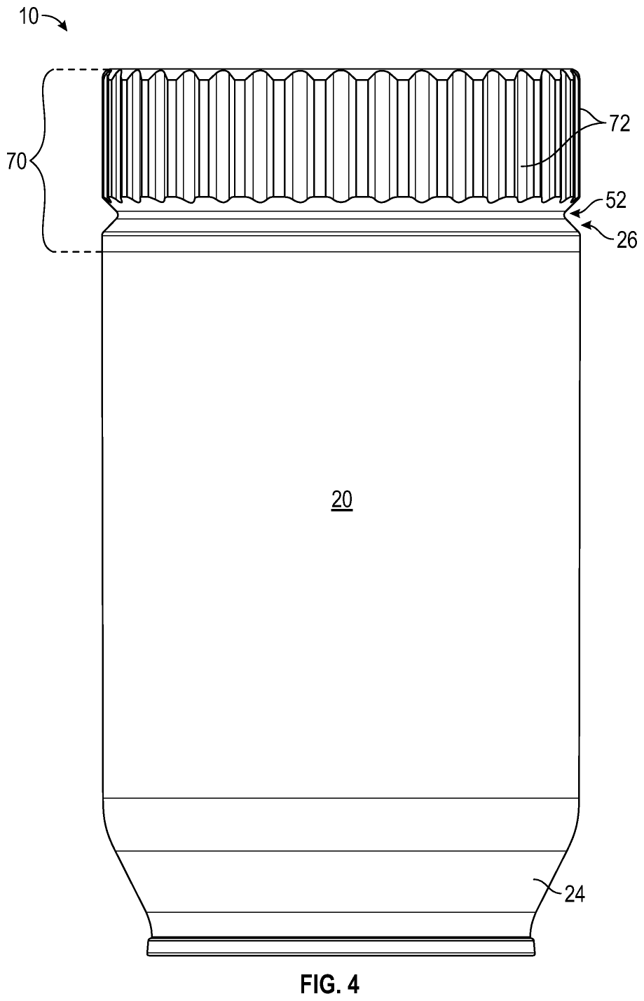

FIG. 4 is a side elevation view of an example embodiment with the upper portion added.

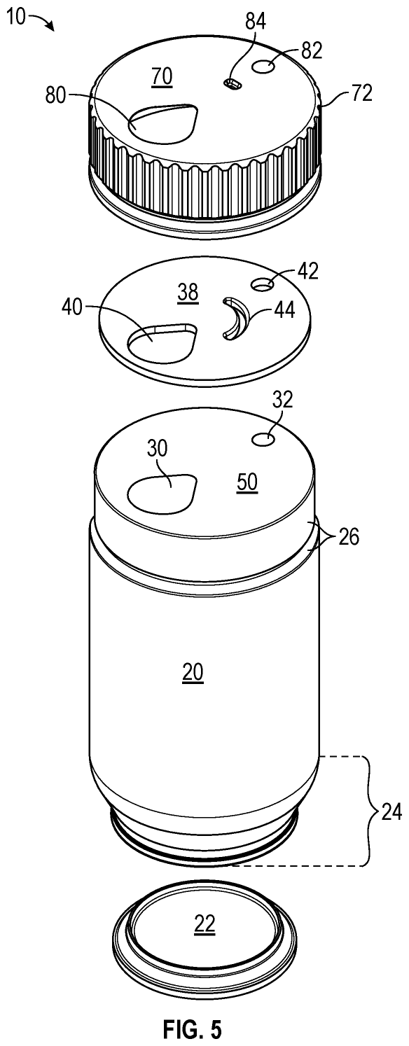

FIG. 5 is an exploded view of an example embodiment showing the container end, impermeable gasket member and upper portion and the lid that is seamed to form the base.

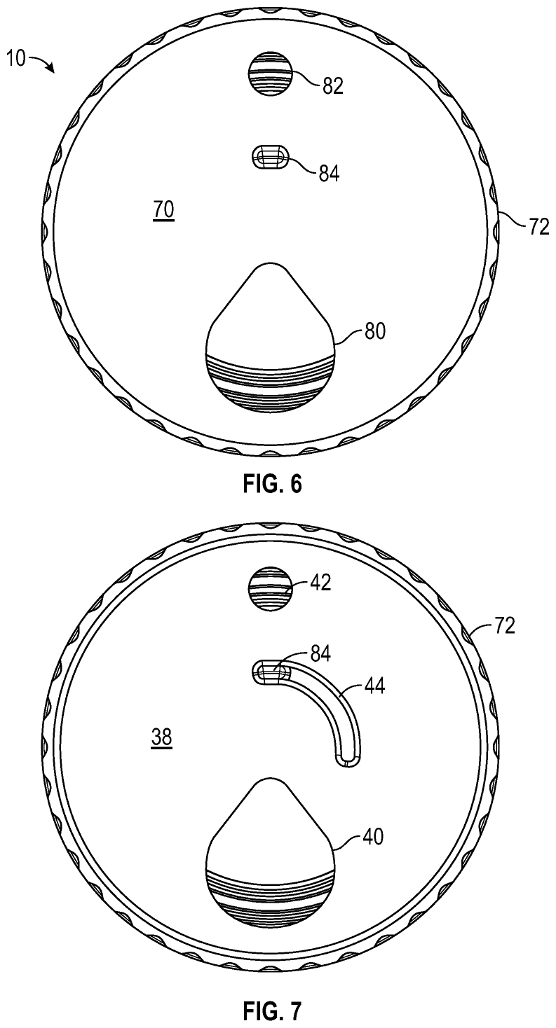

FIG. 6 is a top elevation view of an example embodiment of the upper portion in the open position.

FIG. 7 is a top elevation view of an example embodiment of the upper portion with uppermost portion removed to show the underlying container end with the impermeable gasket installed thereupon in the open position.

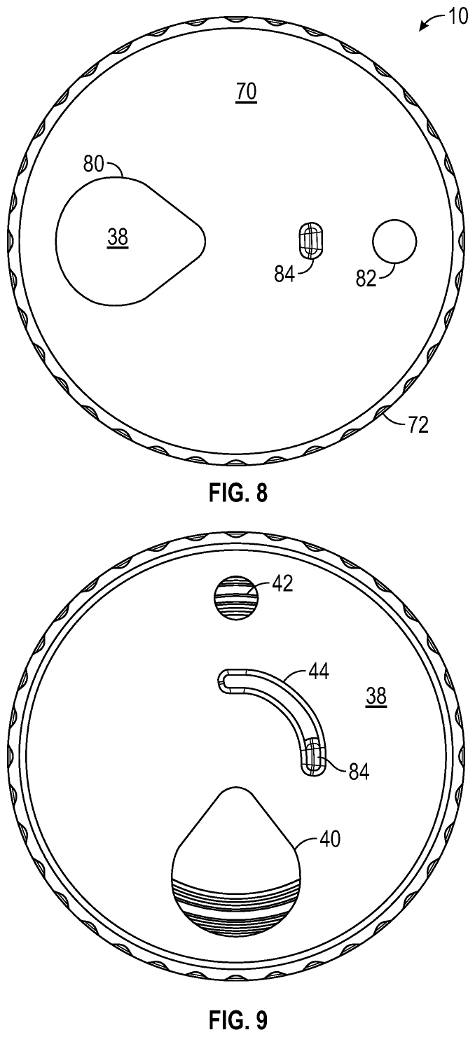

FIG. 8 is a top elevation view of an example embodiment of the upper portion in the closed position.

FIG. 9 is a top elevation view of an example embodiment of the upper portion with uppermost portion removed to show the underlying container end with the impermeable gasket installed thereupon in the closed position.

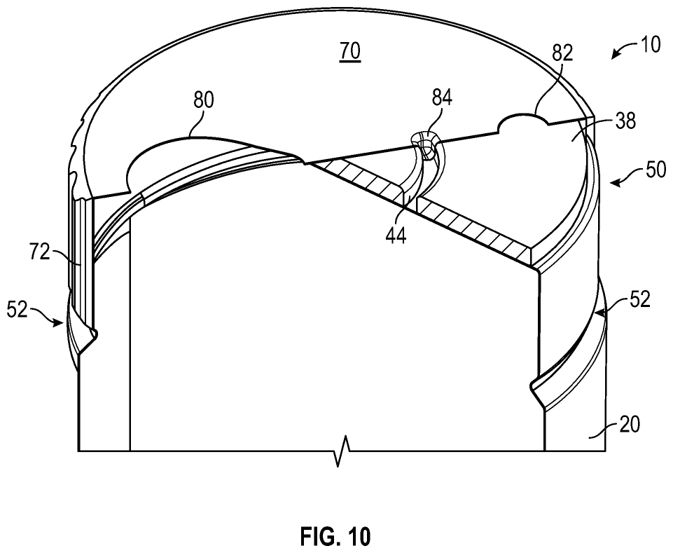

FIG. 10 is a longitudinal section view of an example embodiment of the container end with upper portion rotated to illustrate securement and rotational capacity of the upper portion by action of the detent.

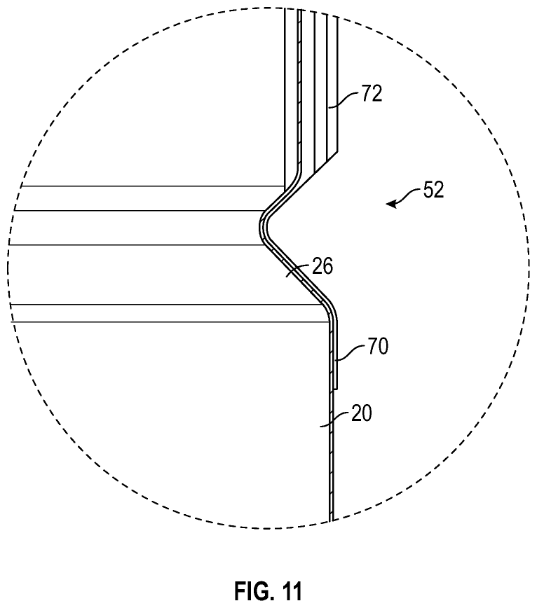

FIG. 11 is a detail view of an example embodiment of the V-crimp disposed to fasten the upper portion to the shoulder of the container end.

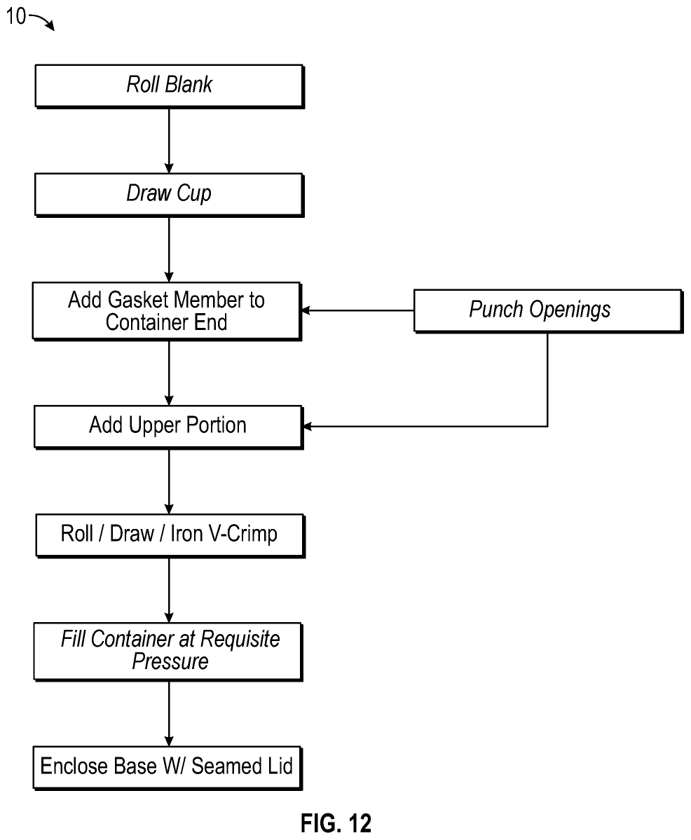

FIG. 12 is a flow diagram of the novel steps in the process of manufacture of the resealable beverage container (non-novel steps shown in italics).

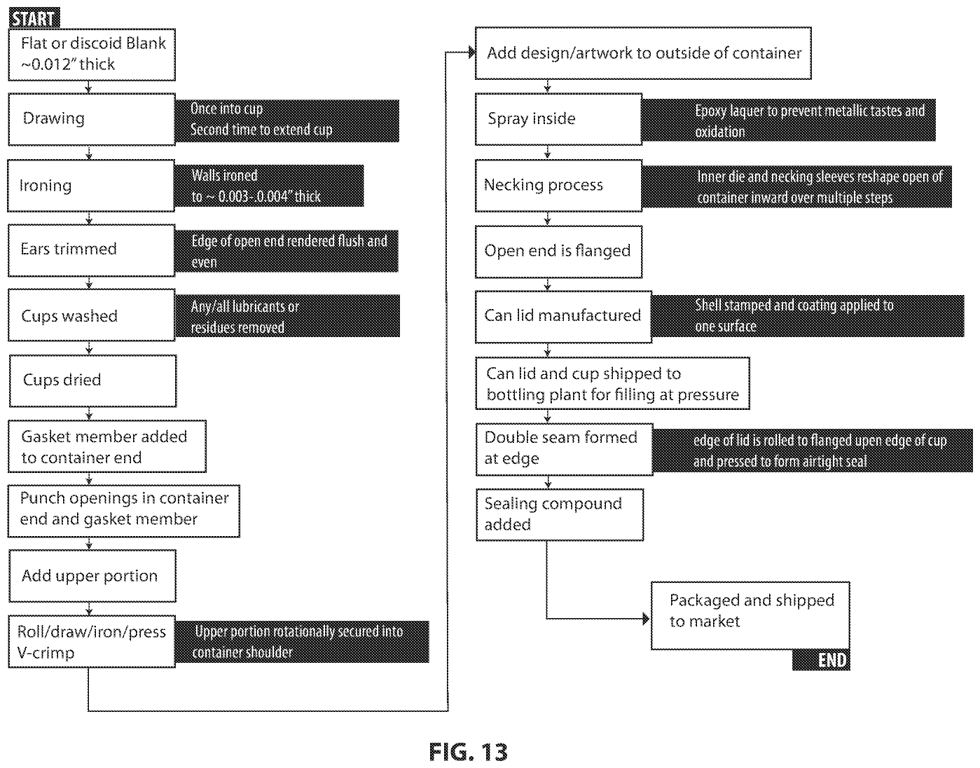

FIG. 13 is a flow diagram of an example embodiment of the method of manufacture of the resealable beverage container.

### DETAILED DESCRIPTION OF THE DRAWINGS

With reference now to the drawings, and in particular FIGS. 1 through 13 thereof, example of the instant resealable beverage container employing the principles and concepts of the present resealable beverage container and generally designated by the reference number 10 will be described.

The instant Figures supplied herewith are intended to be exemplary and not limiting. Alternative means of contemplating the invention illustrated herein that do not contradict the claims should be considered within scope of this disclosure, the metes and bounds of the invention constructed from the accompanying claims. Further, the particular examples depicted in FIGS. 1 through 13 are presented with mind to the method of manufacture herein claimed in addition to the apparatus set forth. The method of manufacture is adaptable to modify current manufacturing processes in the beverage can industry. However some steps may be practicable with materials other than metal, alloy, or aluminum; the inventive step applying to novel features set forth herein and not necessarily to a particular material or via such steps as inform industry standard practices already in the beverage canning arts. Therefore, it is to be understood that the accompanying Figures are provided for example only, to show certain features in practice that may be common to other embodiments not shown herein, without departing from the inventive steps contemplated and set forth.

Referring specifically now to the example embodiment shown in FIG. 1, a raised elevation view of an example embodiment of the instant resealable beverage container 10 is illustrated. In this example embodiment depicted, the beverage container 10 is an aluminum can manufactured by the process set forth herein below, however, it is contemplated that the general form of the operable components (specifically the upper portion and container end and impermeable gasket member) may be employable for a resealable beverage container manufactured of materials other than aluminum.

As shown in FIG. 1, the instant resealable beverage container 10 includes an upper portion 70 disposed overtop a container end 50. The beverage container 10 includes a seamed base 22, a neck 24, a can body 20, a shoulder 26, and the upper portion 70 fitted overtop the container end 50 and engaged with the container end 50 at a V-crimp 52 disposed circumferentially about the can shoulder 26. Outer radius of upper portion 70 is substantially the same length as the outer radius of the can body 20. Upper portion 70 is rotatably engaged to shoulder 26 by V-crimp 52. Upper portion 70 may include material thereupon to assist with rotation upon the container 10 and/or to assist in sealing the openings thereunder.

The upper portion 70 is therefore rotatable upon the container end 50 and includes knurled or milled features 72 circumferentially disposed thereupon to increase tractive engagement with the hands of a user. In this example embodiment depicted, upper portion 70 includes drink hole 80, vent hole 82, and detent member 84. As shown in FIG. 1, upper portion 70 is disposed in a closed position. Rotation of upper portion 70 in a first direction rotates drink hole 80 and vent hole 82 to an open position, overlying a corresponding drink hole 30 and vent hole 32 in the container end 50 (see, e.g., FIGS. 5, 6, 7, and 10). Travel of the upper portion 70 between the closed position and the open position is delimited by action of detent 84 (see, e.g., FIG. 10). Returning upper portion 70 to the closed position reorients drink hole 80 and vent hole 82 overtop impermeable gasket member 38. It should be noted that embodiments are practicable wherein the vent holes 32, 42, and 82 are omitted and wherein detent 84 is disposed elsewhere upon the apparatus 10 to delimit rotation of the upper portion 70 between the open and closed positions.

FIG. 2 illustrates a lowered elevation view of the example embodiment depicted in FIG. 1. The base 22 of the container 10 is shown as a seamed lid installed to the can 20 open end after the beverage has been pressurized therein (see discussion of the method below). In the example embodiment shown, the base 22 is installed in the manner that can lids are currently installed to beverage containers seen in the state of the art; only, here, the drink hole is not scored and no ring pull is added. However, in this example embodiment, the base 22 is seamed into neck 24 of container 10 in known fashion.

Upper portion 70 is attached to container end 50 by the V-crimp 52 crimping the upper end 70 and shoulder 22 together (see, e.g., FIG. 11).

FIG. 3 illustrates a side elevation view of an example embodiment with upper portion 70 excluded from view. Shoulder 26 presents a flat container end 50 as top of the beverage container 10. As will be set forth herein below, in the example embodiment shown, container end 50 is manufactured in the same manner that the base of a typical beverage can is manufactured, by drawing out the beverage container from an aluminum blank at the first stages of drawing and ironing the blank. However, here, container end 50 is not bulged inwards, as is typical in the current state of the art, by a punch—performed in the state of the art to bow or arch the base of the can to resist pressure which, exerted over a smaller area than the associated can side walls, is greater at the base than upon the can side walls—because the upper portion 70, fitted over the container end 50, provides the additional strength to resist the internal pressure applied when the beverage is added and pressurized. Seamed base 22 is rendered of a stronger alloyed aluminum (typically with a higher manganese content) to enable sealing the can 20 and maintaining pressure in the normal fashion applied to can lids as seen in the current state of the art.

Thus, in the example embodiment illustrated herein, the can 20 is manufactured in like manner as seen in the current state of the art, but in-use the can 20 is inverted—the lid is the base of the present resealable beverage container, and the base is modified (with addition of the upper portion) to serve as the container top. It should be noted that the seamed base 22, rendered and seamed in like manner as can lids in the state of the art, enables stacking, packing, and storage of the present resealable beverage container in existing capacity as applied to existing beverage cans known in the art.

FIG. 4 is a side elevation view of the example embodiment of the resealable beverage container illustrated in FIG. 3 having the upper portion attached 70. V-crimp 52 is rendered to maintain upper portion 70 over container end 50 and enables rotational play of upper portion 70 around shoulder 26 to effectuate movement between the open and closed positions. (See also FIG. 11.)

FIG. 5 is an exploded view of the example embodiment depicted in FIG. 4. In this example embodiment, container end 50 is flat and shouldered, as rendered in the drawing and ironing processes (see below) and formed without the bulge as would typically be applied thereto in current practice of the art. Impermeable gasket member 38 is shown as a single body superimposed upon container end 50. Impermeable gasket member 38 may be polymeric, rubberlike, or made of plastic or silicone, or other non-toxic impermeable polymer(s) suited for such purpose. As described above, gasket member 38 may be sprayed onto container end 50, additively printed to container end 50, or otherwise produced and added thereto during the manufacturing process, as a single body or as a plurality of bodies positioned as effective in fulfilling the general purpose set forth herein.

In the example embodiment shown, gasket member 38 includes drink hole 40, vent hole 42, and track member 44. Drink hole 40 superimposes over drink hole 30 in the container end 50 and vent hole 42 superimposes over vent hole 32 in the container end 50. Track member 44 is disposed for engagement with detent member 84, disposed in upper portion 70, when upper portion 70 is added atop gasket member 40. Upper portion 70 is added to container end 50 in the closed position at time of manufacture, whereby drink hole 80 and vent hole 82 in upper portion 70 are disposed overtop of impermeable gasket member 38 to prevent throughflow of fluids from inside the container 10. V-crimp 52 is added once upper portion 70 has been positioned overtop of container end 50. V-crimp 52 is circumscribed into shoulder 26 of container end 50 and serves to fasten upper portion 70 in position while maintaining upper portion's rotational capacity.

Seamed base 22 is connectable to open end of the container 10 and seamed into position in like manner as is seen in the present state of the art in seaming the lid into the container neck. Neck 24 therefore enables seaming and securement of the base 22 in position to prevent detachment or expulsion from the formed container 10. No drink hole or ring pull is added to base 22, however, as would typically be the case during installation of the lid into beverage containers seen in the present state of the art.

In some embodiments, for better securement, a central pivot or pin member (not shown) may be included in upper portion 70 to further secure and attach upper portion 70 to container end 50. This pivot or pin member, or other means of securing the center of upper portion to container end and/or gasket member while enabling rotation thereabouts, may be manufactured in like manner as the pin in beverage cans currently seen in the art to anchor the lever or ring pull in place atop the can lid.

FIG. 6 is a top elevation view of the resealable beverage container shown in FIG. 5 with the upper portion 70 disposed in the open position. Vent hole 82 in upper portion 70 overlies corresponding vent holes 42, 32 in gasket member 38 and container end 50 respectively to enable throughflow of atmosphere into container 10 when liquid is decanted therefrom, whereby atmospheric displacement into the container ensures consistent pouring. Likewise, drink hole 80 in upper portion 70 overlies corresponding drink holes 40, 30 in the gasket member 38 and container end 50 to enable throughflow of liquid therethrough when decanting the container 10 or when drinking directly therefrom.

FIG. 7 is a top elevation view of the resealable beverage container of FIG. 6 with uppermost layer of upper portion 70 removed. Detent 84 is shown seated in the track member 44 at an extremity thereof corresponding to the open position. Rotation of upper portion 70 counterclockwise (in this example embodiment) moves upper portion 70 to the closed position (as shown in FIGS. 8 and 9).

FIG. 8 is a top elevation view of the resealable beverage container shown in FIG. 7 with the upper portion 70 disposed in the closed position. Drink hole 80 and vent hole 82 are disposed over gasket member 38. Before opening beverage container 10 for the first time, by twisting upper portion 70 clockwise in this example embodiment, pressure interior to the container 10 forces engagement of gasket member 38 with upper portion 70 ensuring and maintaining sealed closure.

FIG. 9 is a top elevation view of the resealable beverage container of FIG. 8 with uppermost layer of upper portion 70 removed. Detent 84 is shown seated in the track member 44 at an opposite extremity thereof corresponding to the closed position. Rotation of upper portion 70 clockwise (in this example embodiment) moves upper portion 70 to the open position (as shown in FIGS. 6 and 7).

FIG. 10 is a longitudinal section view of the resealable beverage container shown in FIG. 9, with upper portion 70 then turned midway, illustrating course and action of detent 84 interior to track member 44 in gasket member 38. V-crimp 52 is also shown in upper portion 70 and container shoulder 26 whereby upper portion 70 is secured to, and rotates about, container end 50.

FIG. 11 is a longitudinal section detail view of V-crimp 52, illustrating the overlying contact of upper portion 70 and container shoulder 26 whereby upper portion 70 is rotationally secured to container end 50. During manufacture, V-crimp 52 is impressed below the knurling 72 into upper portion 70 and shoulder 26 simultaneously, circumscribed with pressure applied from V-shaped tool (not shown) against can 20 exterior and supported by a corresponding V-shaped receptacle blank (also not shown) positioned interior to can 20 in opposing relation to tool, whereby the V-crimp 52 is rolled, punched, drawn, ironed, or scored (collectively, “pressed”) into the can body 20 without damaging the container 10.

FIG. 12 is a flow diagram illustrating the steps of an example method of manufacture of the instant resealable beverage container. In the method provided, the aluminum blank is rolled and drawn into a cup (as seen in the present state of the art). However, during the act of ironing to form the shoulder 26 and neck 24 of the cup, the cup base is not arched or bugled inward as is typically seen in the art to compensate for the increased pressure exerted across the surface area of the base relative to the surface area of the surrounding walls. Instead, as has been described previously herein, impermeable gasket member 38 is added thereto (by placement, spray, additive printing, or other suitable method), and upper portion 70 is seated thereover. In this example embodiment, upper portion 70 is devised of aluminum of like tensile strength as the container end 50, or may be devised of a stronger alloy, such as is typically used for can lids practiced in the current state of the art. Upper portion 70 is thereby formed into the shoulder 26 of the container end 50 in formed engagement and close contact therewith.

Upper portion 70 is sized to seat over the container end 50. The container 10 is still open at the other end during this process, and V-crimp 52 is pressed into the upper portion 70 and the shoulder 26 simultaneously by applying focused pressure to the outside of the can body 20 against a V-shaped receptacle blank disposed in corresponding, opposing position upon the interior side of the body 20. The V-crimp 52 is circumscribed around the shoulder 26, molding upper portion 70 to the shoulder 26 in close relation (as shown in FIG. 11). Once the upper portion 70 has been secured to the container end 50, the ears (not shown) are trimmed from the open end as seen in the art, and fluid is added to the container 10 at pressure. Alternatively, the ears may be trimmed at the same time the V-crimp 52 is added, or at another time in the process before fluid is added to the container 10. Once fluid has been added at pressure, the container 10 is enclosed in the manner seen in the present state of the art by seaming a lid (here, base 22) into the open end. The lid (here, base 22) in the instant process, however, is free of additional features such as scored openings or ring pulls or other features.

The process illustrated by FIG. 12 provides utility of the present method with current industry standards and practices. The resulting resealable beverage container 10 is stackable, packable, and shippable in known packaging and container vessels. Simple modification to existing tooling may therefore accommodate and facilitate adoption of the instant method and resealable beverage container 10 industry-wide.

FIG. 13 is a flow diagram of an example method of manufacturing the resealable beverage can 10 in contemplation of integrating the instant method into the current state of the art.

What is claimed is:

1. A resealable beverage container comprising:
a container end having a drink hole disposed therein;
a rotatable upper portion disposed overtop the container end, said upper portion having a drink hole disposed therethrough, said upper portion rotatable between a closed position, wherein the drink hole is misaligned with the drink hole in the container end, and an open position, wherein the drink hole is superimposed atop the drink hole of the container end; and
at least one impermeable gasket member disposed upon the container end between the container end and the upper portion, said gasket member sealing the drink hole in the upper portion when said upper portion is moved to the closed position;
wherein the drink hole of the upper portion alternatively superimposes overtop the drink hole and the impermeable gasket member when the rotatable upper portion is rotated between the closed position and the open position.

2. The resealable beverage container of claim 1 wherein the drink hole of the upper portion superimposes overtop a drink hole in the gasket member when the upper portion is rotated to the open position.

3. The resealable beverage container of claim 1 wherein the container end, the gasket member, and the upper portion each further comprise a vent hole wherein the vent hole of the gasket member is superimposed overtop the vent hole of the container end and wherein the vent hole in the upper portion seats overtop the vent hole of the gasket member when the upper portion is moved to the open position.

4. The resealable beverage container of claim 1 wherein the gasket member is polymeric.

5. The resealable beverage container of claim 1 wherein the upper portion is prevented from over-rotation in each of the open and closed position.

6. The resealable beverage container of claim 4 wherein the gasket member is comprised of food grade silicone.

7. The resealable beverage container of claim 5 wherein the upper portion is prevented from over-rotation by action of at least one detent disposed upon the upper portion, said at least one detent travelable along an extremity of a track disposed in the gasket member, which extremity delimits the open and closed positions of the upper portion.

8. A resealable beverage container comprising:
a container end having a vent hole and a drink hole;
a rotatable upper portion disposed over top the container end, said upper portion having a vent hole, a drink hole, and a detent disposed to delimit rotation of the upper portion upon the container end when the upper portion is rotated from a closed position to an open position; and
an impermeable gasket member superimposed atop the container end between the container end and the upper portion, said gasket member including a vent hole, a drink hole, and a track member, said vent hole and drink hole superimposed atop the vent hole and drink hole upon the container end, and said track member accommodative of the detent between the open and closed positions therein;
wherein the drink hole and the vent hole of the upper portion superimpose overtop the drink hole and vent hole of the gasket member and the corresponding detent engages within the track when the rotatable upper portion is rotated from the closed position to the open position.

9. The resealable beverage container of claim 8 wherein the drink hole of the upper portion seals against the gasket member when the upper portion is rotated to the closed position.

10. The resealable beverage container of claim 8 wherein the gasket member is polymeric.

11. The resealable beverage container of claim 10 wherein the gasket member is comprised of food grade silicone.

12. An improved method of manufacturing an aluminum beverage can from an aluminum blank, the improvement comprising the steps of:
presenting a flat container end having a shoulder after cutting, drawing, punching, and ironing the blank;
adding at least one impermeable gasket member to the exterior of the container end;
adding an upper portion over the container end in close contact with the gasket member and the shoulder;
circumscribing a V-crimp into the upper portion and shoulder of the container end at pressure wherein the upper portion is deformed into the shoulder around the circumference of the V-crimp;
filling the container at pressure; and
seaming a base into the open end.

13. The method of claim 12 further comprising the step of punching openings in the container end and gasket simultaneously.

14. The method of claim 12 further comprising the step of forming the upper portion from aluminum with a higher percentage of manganese than the aluminum blank.

15. The method of claim 12 further comprising the step of forming at least one stop member in the upper portion, said stop member formed to delimit rotation of the upper portion between a closed position and an open position.

16. The method of claim 15 further comprising the step of scoring a track member in the gasket and/or the container end, the extremities of said track member delimiting movement of the at least one stop member between the closed position and the open position.
